(19) United States
(12) Patent Application Publication
(10) Pub. No.: US 2023/0351471 A1
(43) Pub. Date: Nov. 2, 2023

(54) SELLING SYSTEM USING CORRELATION ANALYSIS NETWORK AND METHOD THEREFOR

(71) Applicant: ENTERPRISE BLOCKCHAIN CO., LTD., Seoul (KR)

(72) Inventors: Jihyun LEE, Yongin-si (KR); Seonghyuck YOO, Seoul (KR); Jungjun KIM, Seoul (KR); Jinmo JUNG, Seoul (KR); Junsup LEE, Seoul (KR); Taeho GWAK, Seoul (KR)

(73) Assignee: ENTERPRISE BLOCKCHAIN CO., LTD., Seoul (KR)

(21) Appl. No.: 18/016,963

(22) PCT Filed: Jul. 6, 2021
(86) PCT No.: PCT/KR2021/008549

§ 371 Date: Jan. 19, 2023

(30) Foreign Application Priority Data
Jul. 20, 2020 (KR) 10-2020-0089473

(51) Int. Cl. G06Q 30/0601; G06Q 30/0202; G06N 3/08

(52) U.S. Cl. CPC G06Q 30/0631; G06Q 30/0202; G06N 3/08

(57) ABSTRACT

Disclosed are a selling system using a correlation analysis network, and a method therefor, the system comprising: a collection unit for collecting seller data, product data, and purchaser data; a node acquisition unit for acquiring a plurality of graph nodes including a seller node, a product node, and a purchaser node; a feature acquisition unit for acquiring at least one piece of feature information indicating the attribute value of each of the plurality of graph nodes on the basis of the seller data, the product data, and the purchaser data; an edge acquisition unit for acquiring, on the basis of the at least one piece of feature information, edge information indicating the correlation between the plurality of graph nodes; a graph structure acquisition unit for acquiring a graph structure including the plurality of graph nodes, the at least one piece of feature information about each of the plurality of graph nodes, and the edge information; a learning unit for learning the graph structure by using a graph neural network; and a vector embedding output unit for outputting vector embedding of the plurality of graph nodes on the basis of the graph neural network learning.

### TECHNICAL FIELD

The present invention relates to a sale system and method using a correlation analysis network, and more specifically, to a sale system and method using a correlation analysis network, which recommends a seller, a buyer, and a product group having a high similarity and predicts correlation using a correlation analysis network for sellers, buyers, and products newly introduced to a sale system.

### BACKGROUND ART

With the spread of e-commerce, it is becoming more and more difficult for buyers to purchase products that perfectly match their purchase intentions through sellers who offer optimal conditions in the reality where various sellers and products are pouring out. From the seller's point of view, visually displaying a product that perfectly matches the purchase intention of the buyer is increasing in importance as it has a great impact on sales. Accordingly, as part of meeting the needs of buyers, the recommendation function in the sale system has been in the limelight. The recommendation function is a system that accurately predicts and recommends a product that a buyer wants, and the function of providing a personalized recommendation to a buyer is very important in a sale system.

In particular, in an open sale system in which sellers, buyers, and product information freely interact, the function of recommending products, sellers, and buyers that are predicted to be highly preferred by buyers or sellers to each other is a complicated problem.

Further, in the case of buyers, sellers, and products that are newly introduced into the sale system, it is difficult to provide appropriate recommendations because there is no activity history in the sale system.

### DETAILED DESCRIPTION OF THE INVENTION

### Technical Problem

The present invention has been conceived to respond to the above-described technical problems and aims to provide a sale system and method using a correlation analysis network, which recommends a seller, a buyer, and a product group having a high similarity and predicts correlation using a correlation analysis network for sellers, buyers, and products newly introduced to a sale system, as substantially addressing various issues caused by the limitations and shortcomings of the conventional art and provide a computer-readable recording medium storing a program for executing the method.

### Technical Solution

According to an embodiment of the present invention, a sale method using a correlation analysis network comprises collecting seller data, product data, and buyer data, obtaining a plurality of graph nodes including a seller node, a product node, and a buyer node, obtaining at least one piece of feature information indicating an attribute value of each of the plurality of graph nodes, based on the seller data, the product data, and the buyer data, obtaining edge information indicating a correlation between the plurality of graph nodes, obtained based on the at least one piece of feature information, obtaining a graph structure including the plurality of graph nodes, the at least one piece of feature information about each of the plurality of graph nodes, and the edge information, learning the graph structure using a graph neural network, and outputting vector embeddings of the plurality of graph nodes based on the learning by the graph neural network.

According to an embodiment of the present invention, the seller data includes at least one of name, photo, age, area of activity, field of expertise, field of sale qualification, field of interest, whether to be appointed, number of customers, qualification, sale application activity information, sale history information, and sale feedback information.

According to an embodiment of the present invention, the product data includes at least one of product type, detailed information for each type, product price, and buyer information related to product sale.

According to an embodiment of the present invention, the buyer data includes at least one of name, photo, age, area of residence, marital status, family members, whether to own car, field of interest, sale application activity information, product search history information, product purchase history information, purchased product feedback information, and seller feedback information.

According to an embodiment of the present invention, outputting the vector embeddings of the plurality of graph nodes is a step in which each of the plurality of graph nodes obtains the at least one piece of feature information of a neighbor node, as its own vector embedding, based on the edge information and is a step repeatedly performed while increasing layers one by one.

According to an embodiment of the present invention, the sale method further comprises classifying each of the seller node, the product node, and the buyer node as a group of similar nodes, using unsupervised learning based on the vector embedding.

According to an embodiment of the present invention, the sale method further comprises, when obtaining new seller data not learned by the graph neural network, determining a group with a highest similarity among groups of the similar nodes based on the new seller data and recommending at least one of product information and buyer information based on a vector embedding of at least one seller node belonging to the group with the highest similarity.

According to an embodiment of the present invention, the sale method further comprises, when obtaining new buyer data not learned by the graph neural network, determining a group having a highest similarity among groups of the similar nodes based on the new buyer data and recommending at least one of seller information and product information based on a vector embedding of at least one buyer node belonging to the group with the highest similarity.

According to an embodiment of the present invention, the sale method further comprises, when obtaining new product data not learned by the graph neural network, determining a group having a highest similarity among groups of the similar nodes based on the new product data and recommending at least one of seller information and buyer information based on a vector embedding of at least one product node belonging to the group with the highest similarity.

According to an embodiment of the present invention, the sale method further comprises predicting a corresponding correlation based on the vector embeddings of the plurality of graph nodes when there is no correlation between two nodes among the seller node, the product node, and the buyer node.

According to an embodiment of the present invention, the sale method further comprises classifying a subgraph group including the seller node, the product node, and the buyer node of an entire graph including the vector embeddings of the plurality of graph nodes into a cluster based on a predetermined classification criterion.

Further, according to an embodiment of the present invention, there is included a computer-readable recording medium recording a program for performing the method.

Further, according to an embodiment of the present invention, a sale system using a correlation analysis network comprises a collecting unit collecting seller data, product data, and buyer data, a node obtaining unit obtaining a plurality of graph nodes including a seller node, a product node, and a buyer node, a feature obtaining unit obtaining at least one piece of feature information indicating an attribute value of each of the plurality of graph nodes, based on the seller data, the product data, and the buyer data, an edge obtaining unit obtaining edge information indicating a correlation between the plurality of graph nodes, obtained based on the at least one piece of feature information, a graph structure obtaining unit obtaining a graph structure including the plurality of graph nodes, the at least one piece of feature information about each of the plurality of graph nodes, and the edge information, a learning unit learning the graph structure using a graph neural network, and a vector embedding output unit outputting vector embeddings of the plurality of graph nodes based on the learning by the graph neural network.

According to an embodiment of the present invention, the seller data includes at least one of name, photo, age, area of activity, field of expertise, field of sale qualification, field of interest, whether to be appointed, number of customers, qualification, sale application activity information, sale history information, and sale feedback information.

According to an embodiment of the present invention, the product data includes at least one of product type, detailed information for each type, product price, and buyer information related to product sale.

According to an embodiment of the present invention, the buyer data includes at least one of name, photo, age, area of residence, marital status, family members, whether to own car, field of interest, sale application activity information, product search history information, product purchase history information, purchased product feedback information, and seller feedback information.

According to an embodiment of the present invention, in the vector embedding output unit, each of the plurality of graph nodes obtains the at least one piece of feature information of the neighbor node, as its own vector embedding, based on the edge information and repeats the obtaining of vector embedding while increasing layers one by one.

According to an embodiment of the present invention, the sale system further comprises a classifying unit classifying each of the seller node, the product node, and the buyer node as a group of similar nodes, using unsupervised learning based on the vector embedding.

According to an embodiment of the present invention, the sale system further comprises a first similarity group determining unit, when obtaining new seller data not learned by the graph neural network, determining a group with a highest similarity among groups of the similar nodes based on the new seller data and a first recommending unit recommending at least one of product information and buyer information based on a vector embedding of at least one seller node belonging to the group with the highest similarity.

According to an embodiment of the present invention, the sale system further comprises a second similarity group determining unit, when obtaining new buyer data not learned by the graph neural network, determining a group having a highest similarity among groups of the similar nodes based on the new buyer data and a second recommending unit recommending at least one of seller information and product information based on a vector embedding of at least one buyer node belonging to the group with the highest similarity.

According to an embodiment of the present invention, the sale system further comprises a third similarity group determining unit, when obtaining new product data not learned by the graph neural network, determining a group having a highest similarity among groups of the similar nodes based on the new product data and a third recommending unit recommending at least one of seller information and buyer information based on a vector embedding of at least one product node belonging to the group with the highest similarity.

According to an embodiment of the present invention, the sale system further comprises a predicting unit predicting a corresponding correlation based on the vector embeddings of the plurality of graph nodes when there is no correlation between two nodes among the seller node, the product node, and the buyer node.

According to an embodiment of the present invention, the classifying unit classifies a subgraph group including the seller node, the product node, and the buyer node of an entire graph including the vector embeddings of the plurality of graph nodes into a cluster based on a predetermined classification criterion.

### Advantageous Effects

According to the present invention, it is possible to determine a high-similarity seller, buyer, and product group using a correlation analysis network for sellers, buyers, and products newly introduced into the sale system and having no activity history and incorporate into a corresponding group. Therefore, the newly introduced seller, buyer, and product may obtain features (vector embeddings) of the group having the high similarity and use it for decision making in the sale system. For example, the new seller may obtain features, such as sale records of other sellers by being incorporated into the seller group having a high similarity thereto and be helped in finding an optimal buyer. The new buyer may identify features, such as the sellers with whom other buyers have transacted by being incorporated into the buyer group having a high similarity thereto and be helped in selecting an optimal seller. When a new product is introduced, it is possible to identify features related to the sellers and/or buyers of other products by being incorporated into a product group having a high similarity and to receive help in determining what seller may sell the produce well and what buyers the product needs to be recommended to.

Further, according to the present invention, even when there is no correlation between the seller, the product, and the buyer, it is possible to predict the correlation between the seller, the product, and the buyer based on a correlation analysis network trained using a graph neural network (GNN). For example, if there is a new product and a new buyer newly introduced into the sale system, the corresponding buyer may be predicted to have a high chance of buying the corresponding product by finding a pair to be highly likely to be connected to each other. Further, it is possible to determine whether the corresponding seller succeeds in making a transaction with the corresponding buyer by predicting the possibility of connection between the seller and the buyer for whom the correlation is not identified.

Further, according to the present invention, it is possible to classify the group (seller/product/buyer group) including the seller, product, and buyer of the correlation analysis network trained using a graph neural network as a cluster based on a predetermined classification criterion and establish a sale strategy for each cluster. For example, it is possible to classify the seller/product/buyer group of the trained correlation analysis network as a cluster based on the activity in the sale system and recommend the product transacted in an active cluster to another seller/product/buyer group in the same cluster to thereby increasing sales for the other seller/product/buyer. Further, when a new seller/product/buyer node group is created, the transaction activity level of the group may be predicted, so that a promotion for prompting the use of the sale system is provided to groups expected to have low activity while a promotion for increasing royalty to the sale system is provided to groups expected to have high activity.

### BRIEF DESCRIPTION OF THE DRAWINGS

FIG. 1 is a block diagram schematically illustrating a sale system using a correlation analysis network according to an embodiment of the present invention;

FIG. 2 schematically illustrates a graph structure to be learned by a graph neural network according to an embodiment of the present invention;

FIG. 3 schematically illustrates a node vector embedding of a single layer output as a result of learning by a graph neural network according to an embodiment of the present invention;

FIG. 4 schematically illustrates node vector embeddings of a plurality of layers output as a result of learning by a graph neural network according to an embodiment of the present invention;

FIG. 5 is an example view illustrating prediction of an inter-node correlation according to an embodiment of the present invention; and

FIG. 6 is a block diagram schematically illustrating a sale method using a correlation analysis network according to an embodiment of the present invention.

### MODE FOR CARRYING OUT THE INVENTION

Hereinafter, preferred embodiments of the present invention are described in detail with reference to the accompanying drawings. In the drawings, the same reference numerals refer to the same elements, and the size of each component in the drawings may be exaggerated for clarity of description.

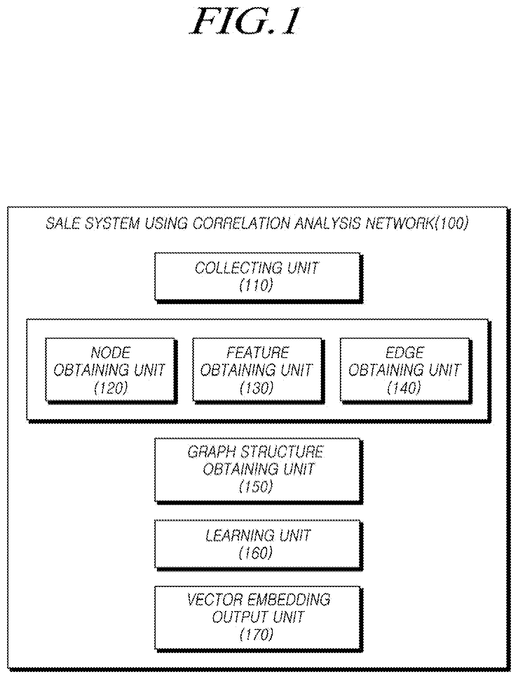

FIG. 1 is a block diagram schematically illustrating a sale system using a correlation analysis network according to an embodiment of the present invention.

According to an embodiment of the present invention, a sale system 100 using a correlation analysis network may include a collecting unit 110, a node obtaining unit 120, a feature obtaining unit 130, an edge obtaining unit 140, a graph structure obtaining unit 150, a learning unit 160, and a vector embedding output unit 170. The sale system 100 using a correlation analysis network may further include a classifying unit (not shown), a first similarity group determining unit (not shown), a first recommending unit (not shown), a second similarity group determining unit (not shown), a second recommending unit (not shown), a third similarity group determining unit (not shown), a third recommending unit (not shown), and a predicting unit (not shown).

The collecting unit 110 collects seller data, product data, and buyer data.

The seller data includes at least one of name, photo, age, area of activity, field of expertise, field of sale qualification, field of interest, whether to be appointed, number of customers, qualification, sale application activity information, sale history information, and sale feedback information. The sale application activity information includes the number of times the sale application is used for a predetermined period (e.g., one day), product search history, and product search time.

The product data includes at least one of product type, detailed information for each type, product price, and buyer information related to product sale.

The buyer data includes at least one of name, photo, age, area of residence, marital status, family members, whether to own car, field of interest, sale application activity information, product search history information, product purchase history information, purchased product feedback information, and seller feedback information.

The node obtaining unit 120 obtains a plurality of graph nodes including a seller node, a product node, and a buyer node.

The feature obtaining unit 130 obtains at least one piece of feature information indicating an attribute value of each of the plurality of graph nodes, based on the seller data, the product data, and the buyer data.

The edge obtaining unit 140 obtains edge information indicating a correlation between the plurality of graph nodes, obtained based on the at least one piece of feature information.

The graph structure obtaining unit 150 obtains a graph structure (or network) including the plurality of graph nodes, the at least one feature information about each of the plurality of graph nodes, and the edge information.

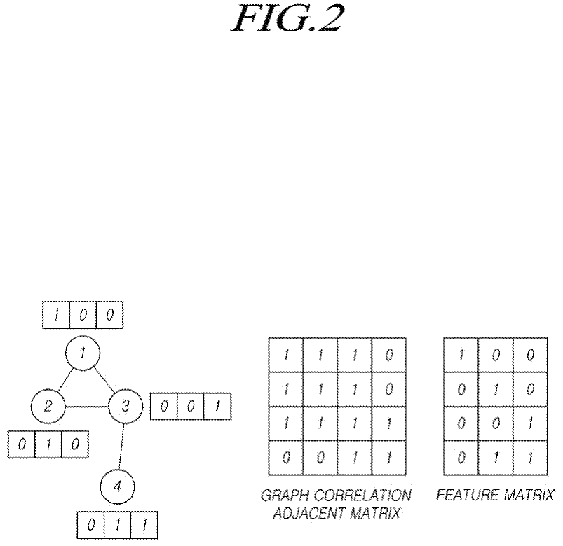

The graph structure to be learned by the graph neural network is described below in detail in connection with FIG. 2.

The learning unit 160 learns the graph structure using a graph neural network (GNN). The graph neural network is an artificial intelligence algorithm that receives a graph structure including graph nodes, feature information about each node, and edge information between nodes and learns based on the graph structure.

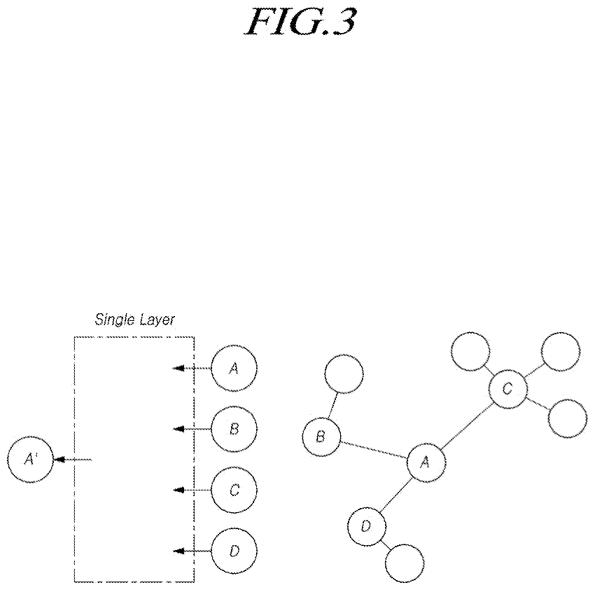

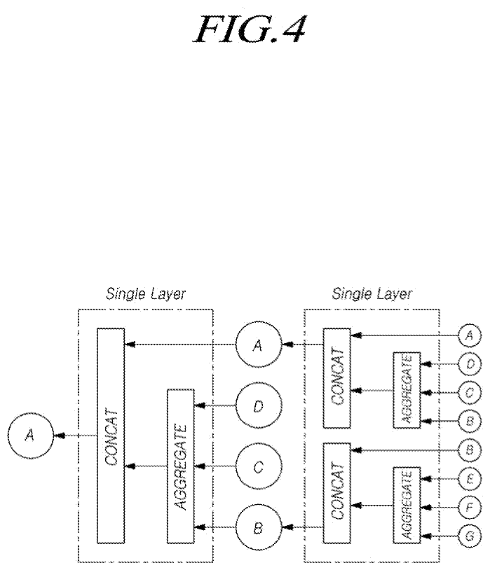

The vector embedding output unit 170 outputs vector embeddings of the plurality of graph nodes based on learning using the graph neural network. In the vector embedding output unit 170, each of the plurality of graph nodes obtains the at least one piece of feature information of the neighbor node, as its own vector embedding, based on the edge information and repeats the obtaining of vector embedding while increasing layers one by one. Each node may obtain all feature information about nodes that are directly or indirectly correlated (adjacent) through vector embedding. Therefore, each node may build a correlation analysis network through vector embedding. A specific operation of the vector embedding output unit 170 is described below with reference to FIGS. 3 and 4.

According to the present embodiment, it is possible to grasp various correlations, such as whether to perform a purchase transaction between seller and buyer, whether to share buyers between sellers, and whether to purchase between buyer and product, in the sale system through vector embedding of each node.

The classifying unit (not shown) classifies each of the seller node, the product node, and the buyer node into a group of similar nodes by unsupervised learning, based on the vector embedding obtained by the vector embedding output unit 170.

When obtaining new seller data not learned by the graph neural network, the first similarity group determining unit (not shown) determines a group having the highest similarity among the groups of similar nodes based on the new seller data. The first similarity group determining unit (not shown) may incorporate the new seller into the group having the highest similarity. Therefore, the new seller may obtain features (vector embeddings) of the group having the high similarity and use it for decision making in the sale system.

The first recommending unit (not shown) recommends at least one of product information and buyer information based on the vector embedding of at least one seller node belonging to the group having the highest similarity. For example, the new seller may obtain features, such as sale records of other sellers belonging to the group with the highest similarity and be helped in finding an optimal buyer.

When obtaining new buyer data not learned by the graph neural network, the second similarity group determining unit (not shown) determines a group having the highest similarity among the groups of similar nodes based on the new buyer data. The second similarity group determining unit (not shown) may incorporate the new buyer into the group having the highest similarity. Therefore, the new buyer may obtain features (vector embeddings) of the group having the high similarity and use it for decision making in the sale system.

The second recommending unit (not shown) recommends at least one of seller information and product information based on the vector embedding of at least one buyer node belonging to the group having the highest similarity. For example, the new buyer may identify features, such as the sellers with whom other buyers belonging to the group with the highest similarity have transacted and be helped in selecting an optimal seller.

When obtaining new product data not learned by the graph neural network, the third similarity group determining unit (not shown) determines a group having the highest similarity among the groups of similar nodes based on the new product data. The third similarity group determining unit (not shown) may incorporate the new product into the group having the highest similarity. Therefore, the new product may obtain features (vector embeddings) of the group having the high similarity and use it for decision making in the sale system.

The third recommending unit (not shown) recommends at least one of seller information and buyer information based on the vector embedding of at least one product node belonging to the group having the highest similarity. For example, when a new product is introduced, it is possible to identify features related to the sellers and/or buyers of other products belonging to the group with the highest similarity and to receive help in determining what seller may sell the produce well and what buyers the product needs to be recommended to.

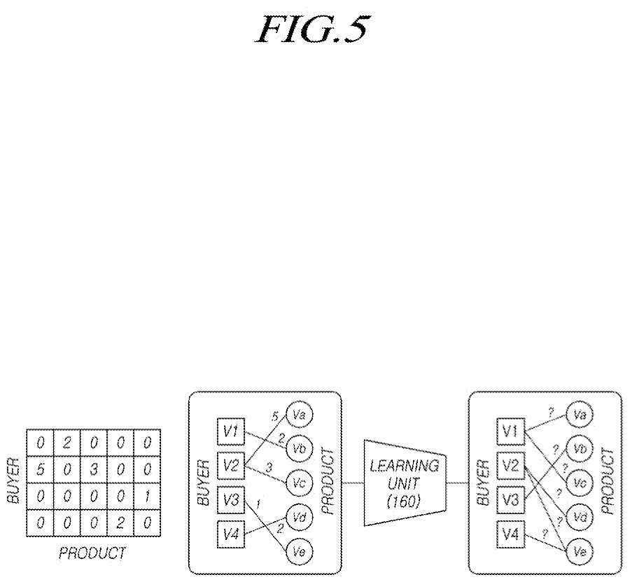

The predicting unit (not shown) predicts the correlation based on the vector embeddings of the plurality of graph nodes when there is no correlation between two nodes among the seller node, the product node, and the buyer node. An example showing correlation prediction between nodes is described below in connection with FIG. 5.

The classifying unit (not shown) may further classify the subgraph group including the seller node, the product node, and the buyer node of the entire graph including the vector embeddings of the plurality of graph nodes into a cluster based on a predetermined classification criterion and establish a sale strategy for each cluster. For example, the classifying unit (not shown) may further classify the subgraph group including the seller node, the product node, and the buyer node of the entire graph including the vector embeddings of the plurality of graph nodes into a cluster based on the activity in the sale system 100 and recommend the product transacted in an active cluster to another seller node/product node/buyer node in the same cluster, thereby increasing the sales of the other groups. Further, when a new seller node/product node/buyer node group is created, the transaction activity level of the group may be predicted, so that a promotion for prompting the use of the sale system is provided to groups expected to have low activity while a promotion for increasing royalty to the sale system is provided to groups expected to have high activity.

FIG. 2 schematically illustrates a graph structure to be learned by a graph neural network according to an embodiment of the present invention.

In the illustrated example, a plurality of graph nodes including a seller node, a product node, and a buyer node are shown as circles. Feature information representing the attribute value of each of the plurality of graph nodes is shown as a square box at the top of the corresponding node. Edge information indicating the correlation between the plurality of graph nodes, which is obtained based on the at least one piece of feature information, is shown as a connection line between nodes.

In the illustrated example, the feature matrix includes the feature information about node 1, node 2, node 3, and node 4 in each row. For example, node 1 has feature information [1, 0, 0].

In the illustrated example, the graph correlation adjacent matrix includes edge information representing correlations between node 1, node 2, node 3, and node 4. For example, node 1 has edge information [1, 1, 1, 0], indicating that there is a correlation with itself, node 2, and node 3.

FIG. 3 schematically illustrates node vector embedding of a single layer output as a result of learning by a graph neural network according to an embodiment of the present invention.

The vector embedding output unit 170 of the sale system 100 using the correlation analysis network according to the present embodiment outputs vector embeddings of a plurality of graph nodes based on graph neural network learning. Vector embedding of each node means feature information about nodes that are directly or indirectly correlated (adjacent).

The vector embedding output unit 170 repeatedly performs obtaining of vector embedding while increasing the layers one by one. Each node in one layer obtains a vector embedding by combining the feature information about its neighbors on the graph and its own feature information through the vector embedding output unit 170. FIG. 3 illustrates an example of performing graph neural network learning with one layer for node A having neighbor nodes B, C, and D. In the illustrated example, the vector embedding of node A may include feature information about nodes B, C, and D together with feature information about node A. Node A may obtain features of other nodes correlated with itself through vector embedding, as feature information.

FIG. 4 schematically illustrates node vector embeddings of a plurality of layers output as a result of learning by a graph neural network according to an embodiment of the present invention.

FIG. 4 illustrates an example in which node A has neighbor nodes B, C, and D, node B has neighbor nodes E, F, and G, and graph neural network learning is performed with two layers. In the illustrated example, the vector embedding of node A includes feature information about node A, feature information about neighbor nodes B, C, and D, and feature information about neighbor nodes E, F, and G of neighbor node B.

hᵥ^{k} is defined as the vector embedding of node v after passing through the kth layer, and an algorithm for obtaining hᵥ^{k} is as follows.

for v in V:

h_{v}\hat{ }{0}=(feature vector of v)

for i in range(1, k+1):

for v in V:

a=AGGREGATE({h_{u}\hat{ }{i−1}|{u, v} in E})

h_{v}\hat{ }{i}=CONCAT(h_{v}\hat{ }{i−1}, a)

FIG. 5 is an example view illustrating prediction of an inter-node correlation according to an embodiment of the present invention.

The predicting unit (not shown) of the sale system 100 using a correlation analysis network according to the present embodiment predicts the correlation based on the vector embeddings of the plurality of graph nodes when there is no correlation between two nodes among the seller node, the product node, and the buyer node.

In the illustrated example, a correlation between a buyer node and a product node based on purchased product feedback information between the buyer node and the product node is shown. In the illustrated example, the purchased product feedback information refers to the buyer's satisfaction score for the purchased product. For example, the satisfaction score of the node V1 buyer for product Vb is 2, and the satisfaction scores of the node V2 buyer for product Va and Vc are 5 and 3, respectively. The predicting unit (not shown) may predict satisfaction scores of the node V1 buyer for products Va and Vc based on the vector embeddings of the plurality of graph nodes.

As shown in the example, according to the present embodiment, even when there is no correlation between the seller, the product, and the buyer, it is possible to predict the correlation between the seller, the product, and the buyer based on a correlation analysis network obtained through graph neural network learning. For example, if there is a new product and a new buyer newly introduced into the sale system, the corresponding buyer may be predicted to have a high chance of buying the corresponding product by finding a pair to be highly likely to be connected to each other. Further, it is possible to determine whether the corresponding seller succeeds in making a transaction with the corresponding buyer by predicting the possibility of connection between the seller and the buyer for whom the correlation is not identified.

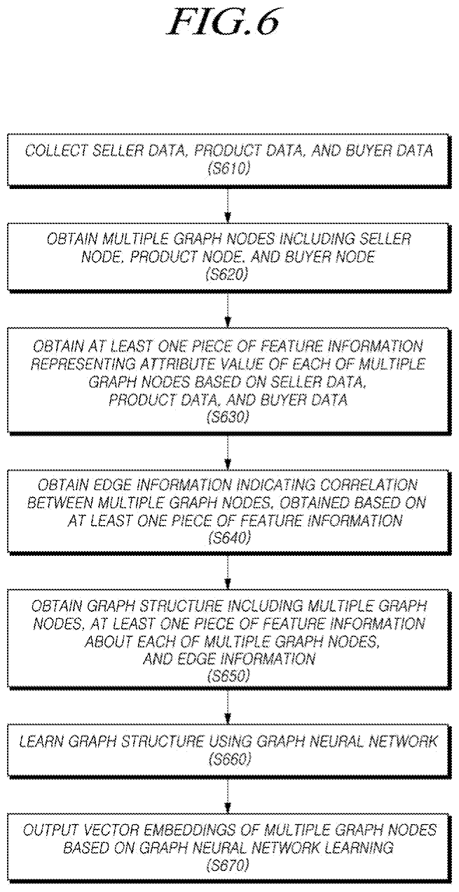

FIG. 6 is a flowchart schematically illustrating a sale method using a correlation analysis network according to an embodiment of the present invention.

In step S610, the sale system 100 using the correlation analysis network collects seller data, product data, and buyer data by the collecting unit 110.

The seller data includes at least one of name, photo, age, area of activity, field of expertise, field of sale qualification, field of interest, whether to be appointed, number of customers, qualification, sale application activity information, sale history information, and sale feedback information.

The product data includes at least one of product type, detailed information for each type, product price, and buyer information related to product sale.

The buyer data includes at least one of name, photo, age, area of residence, marital status, family members, whether to own car, field of interest, sale application activity information, product search history information, product purchase history information, purchased product feedback information, and seller feedback information.

In step S620, the sale system 100 using the correlation analysis network obtains a plurality of graph nodes including a seller node, a product node, and a buyer node by the node obtaining unit 120.

In step S630, the sale system 100 using the correlation analysis network obtains at least one piece of feature information indicating an attribute value of each of the plurality of graph nodes, based on the seller data, the product data, and the buyer data, by the feature obtaining unit 130.

In step S640, the sale system 100 using the correlation analysis network obtains edge information indicating a correlation between the plurality of graph nodes, obtained based on the at least one piece of feature information, by the edge obtaining unit 140.

In step S650, the sale system 100 using the correlation analysis network obtains a graph structure including the plurality of graph nodes, the at least one feature information about each of the plurality of graph nodes, and the edge information, by the graph structure obtaining unit 150.

In step S660, the sale system 100 using the correlation analysis network learns the graph structure using the graph neural network, by the learning unit 160.

In step S670, the sale system 100 using the correlation analysis network outputs vector embeddings of a plurality of graph nodes based on graph neural network learning, by the vector embedding output unit 170. Step S670 is a step in which each of the plurality of graph nodes obtains the at least one piece of feature information of the neighbor node, as its own vector embedding, based on the edge information and is the step of repeating the obtaining of vector embedding while increasing layers one by one.

The sale system 100 using the correlation analysis network further includes the step (not shown) of classifying each of the seller node, the product node, and the buyer node into a group of similar nodes by unsupervised learning, based on the vector embedding, by the classifying unit.

The sale system 100 using the correlation analysis network further comprises, when obtaining new seller data not learned by the graph neural network, determining (not shown) a group with a highest similarity among groups of the similar nodes based on the new seller data, by the first similarity group determining unit, and recommending (not shown) at least one of product information and buyer information based on a vector embedding of at least one seller node belonging to the group with the highest similarity, by the first recommending unit.

The sale system 100 using the correlation analysis network further comprises, when obtaining new buyer data not learned by the graph neural network, determining (not shown) a group having a highest similarity among groups of the similar nodes based on the new buyer data, by the second similarity group determining unit, and recommending (not shown) at least one of seller information and product information based on a vector embedding of at least one buyer node belonging to the group with the highest similarity, by the second recommending unit.

The sale system 100 using the correlation analysis network further comprises, when obtaining new product data not learned by the graph neural network, determining (not shown) a group having a highest similarity among groups of the similar nodes based on the new product data, by the third similarity group determining unit, and recommending (not shown) at least one of seller information and buyer information based on a vector embedding of at least one product node belonging to the group with the highest similarity, by the third recommending unit.

The sale system 100 using the correlation analysis network further comprises predicting (not shown) the correlation based on the vector embedding of the plurality of graph nodes when there is no correlation between two nodes among the seller node, the product node, and the buyer node, by the predicting unit.

The sale system 100 using the correlation analysis network further comprises classifying (not shown) a subgraph group including the seller node, the product node, and the buyer node of an entire graph including the vector embeddings of the plurality of graph nodes into a cluster based on a predetermined classification criterion, by the classifying unit.

Although preferred embodiments of the present invention have been described above in detail, the scope of the present invention is not limited thereto, and various modifications and equivalent other embodiments are possible. Thus, the true technical scope of the present invention should be defined by the appended claims.

For example, a device according to an example embodiment of the present invention may include a bus coupled to each of the units of the device as shown, and at least one processor coupled to the bus and may include a memory coupled to the bus to store commands, received messages, or generated messages and coupled to the at least one processor to perform the above-described commands.

Further, the system according to the present invention may be implemented as computer-readable code in a recording medium. The computer-readable recording medium includes all types of recording devices storing data readable by a computer system. The computer-readable recording medium includes a magnetic storage medium (e.g., a ROM, a floppy disk, or a hard disk) or an optical reading medium (e.g., a CD-ROM or a DVD). Further, the computer-readable recording medium may be distributed to computer systems connected via a network, and computer-readable codes may be stored and executed in a distributed manner.

1. A sale method using a correlation analysis network, comprising:
collecting seller data, product data, and buyer data;
obtaining a plurality of graph nodes including a seller node, a product node, and a buyer node;
obtaining at least one piece of feature information indicating an attribute value of each of the plurality of graph nodes, based on the seller data, the product data, and the buyer data;
obtaining edge information indicating a correlation between the plurality of graph nodes, obtained based on the at least one piece of feature information;
obtaining a graph structure including the plurality of graph nodes, the at least one piece of feature information about each of the plurality of graph nodes, and the edge information;
learning the graph structure using a graph neural network; and
outputting vector embeddings of the plurality of graph nodes based on the learning by the graph neural network.

2. The sale method of claim 1, wherein the seller data includes at least one of name, photo, age, area of activity, field of expertise, field of sale qualification, field of interest, whether to be appointed, number of customers, qualifications, sale application activity information, sale history information, and sale feedback information.

3. The sale method of claim 1, wherein the product data includes at least one of product type, detailed information for each type, product price, and buyer information related to product sale.

4. The sale method of claim 1, wherein the buyer data includes at least one of name, photo, age, area of residence, marital status, family members, whether to own car, field of interest, sale application activity information, product search history information, product purchase history information, purchased product feedback information, and seller feedback information.

5. The sale method of claim 1, wherein outputting the vector embeddings of the plurality of graph nodes is a step in which each of the plurality of graph nodes obtains the at least one piece of feature information of a neighbor node, as its own vector embedding, based on the edge information and is a step repeatedly performed while increasing layers one by one.

6. The sale method of claim 1, further comprising classifying each of the seller node, the product node, and the buyer node as a group of similar nodes, using unsupervised learning based on the vector embedding.

7. The sale method of claim 6, further comprising:
when obtaining new seller data not learned by the graph neural network, determining a group with a highest similarity among groups of the similar nodes based on the new seller data; and
recommending at least one of product information and buyer information based on a vector embedding of at least one seller node belonging to the group with the highest similarity.

8. The sale method of claim 6, further comprising:
when obtaining new buyer data not learned by the graph neural network, determining a group having a highest similarity among groups of the similar nodes based on the new buyer data; and
recommending at least one of seller information and product information based on a vector embedding of at least one buyer node belonging to the group with the highest similarity.

9. The sale method of claim 6, further comprising:
when obtaining new product data not learned by the graph neural network, determining a group having a highest similarity among groups of the similar nodes based on the new product data; and
recommending at least one of seller information and buyer information based on a vector embedding of at least one product node belonging to the group with the highest similarity.

10. The sale method of claim 1, further comprising predicting a corresponding correlation based on the vector embeddings of the plurality of graph nodes when there is no correlation between two nodes among the seller node, the product node, and the buyer node.

11. The sale method of claim 1, further comprising classifying a subgraph group including the seller node, the product node, and the buyer node of an entire graph including the vector embeddings of the plurality of graph nodes into a cluster based on a predetermined classification criterion.

12. A computer-readable recording medium storing a program for performing the method of claim 1.

13. A sale system using a correlation analysis network, comprising:
a collecting unit collecting seller data, product data, and buyer data;
a node obtaining unit obtaining a plurality of graph nodes including a seller node, a product node, and a buyer node;
a feature obtaining unit obtaining at least one piece of feature information indicating an attribute value of each of the plurality of graph nodes, based on the seller data, the product data, and the buyer data;
an edge obtaining unit obtaining edge information indicating a correlation between the plurality of graph nodes, obtained based on the at least one piece of feature information;
a graph structure obtaining unit obtaining a graph structure including the plurality of graph nodes, the at least one piece of feature information about each of the plurality of graph nodes, and the edge information;
a learning unit learning the graph structure using a graph neural network; and
a vector embedding output unit outputting vector embeddings of the plurality of graph nodes based on the learning by the graph neural network.

14. The sale system of claim 13, further comprising a classifying unit classifying each of the seller node, the product node, and the buyer node as a group of similar nodes, using unsupervised learning based on the vector embedding.

15. The sale system of claim 14, further comprising:
a first similarity group determining unit, when obtaining new seller data not learned by the graph neural network, determining a group with a highest similarity among groups of the similar nodes based on the new seller data; and
a first recommending unit recommending at least one of product information and buyer information based on a vector embedding of at least one seller node belonging to the group with the highest similarity.
